(19) United States
(12) Patent Application Publication
(10) Pub. No.: US 2008/0223666 A1
(43) Pub. Date: Sep. 18, 2008

(54) Traction Arrangements

(76) Inventor: Anthony Cuthbert, Newtown (GB)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/995,169

(22) PCT Filed: Jun. 26, 2006
(86) PCT No.: PCT/GB2006/002339

§ 371 Date: May 1, 2008

(30) Foreign Application Priority Data
Jul. 9, 2005 (GB) 0514181.7
Nov. 5, 2005 (GB) 0522614.7
Dec. 16, 2005 (GB) 0525612.8
Apr. 1, 2006 (GB) 0600044.2

(51) Int. Cl. B66B 1/28; B66B 1/32

(52) U.S. Cl. 187/288; 187/293

(57) ABSTRACT

A traction arrangement comprises a track, a carriage, guide means guiding the carriage along the track with a predetermined carriage/track gap, and eddy current means generating eddy current across the gap giving rise to a traction force. Such an arrangement has utility in ropeless elevator systems.

### CROSS REFERENCE TO RELATED APPLICATIONS

This application claims priority from PCT Application PCT/GB2006/002339 filed on 26 Jun. 2006, which application claims priority to application GB 0514181.7 filed 9 Jul. 2005. The PCT/GB2006/002339 and the GB 0514181.7 are incorporated by reference herein, in their entirety, for all purposes.

### BACKGROUND AND SUMMARY

This invention relates to traction arrangements. The invention has particular relevance in connection with elevators, which move, essentially, vertically, but is also of interest in connection with traction arrangements for movement essentially horizontally.

Elevators are conventionally moved up and down by a hoisting motor situated at the top of an elevator shaft, hoisting the elevator carriage by ropes, usually wire ropes. The carriage is usually balanced by a counterweight.

This arrangement has worked well for over a century, but is not well suited for the higher rise buildings of more recent times. A potential answer to many of the problems is the ropeless elevator concept, in one realisation of which the elevator carriage is driven by means of a linear motor.

A linear motor is essentially a rotary electric motor that has had its stator Opened out into a straight line so as to produce linear rather than rotary motion. Linear motors have been used for rail traction, and form an element of the ‘maglev’ concept.

One problem with linear motor driven elevators to date has been that they are not nearly so fast as rope elevators. Rope elevators can achieve rates of ascent of over 1000 m/min, whereas linear motor driven elevators have only achieved about a third of that speed.

Another problem is braking, especially emergency braking if the power should fail. Conventional rope safety systems do not work with linear motor driven carriages. Yet another problem is cost—a linear motor is very expensive, when considered for a high rise elevator drive, as the stator, which might be a series of permanent magnets or coils has to extend the length of the shaft.

The present invention provides a traction arrangement which is well suited to a ropeless elevator system, but which can also be useful in other traction arrangements.

The invention comprises a traction arrangement comprising:

a track;

a carriage;

guide means guiding the carriage along the track with a predetermined carriage/track gap; and

eddy current means generating eddy current across the gap giving rise to a traction force.

This is, essentially, an eddy current motor, used in a traction setting. Eddy current motors are not usually regarded seriously for any commercial application—they are among the simplest of motors, requiring only a rotating magnetic field generator and a conductive shell rotor, the stuff of school physics textbooks. Surprisingly, an eddy current motor has been found to work well in a traction setting. It may be realised in a number of configurations.

The eddy current means may comprise a moving magnetic field arrangement on one side of the gap and an electrically conductive armature on the other side of the gap.

The eddy current means may comprise multiple moving magnetic field arrangements and electrically conductive armatures. The moving magnetic field arrangements may be on one side of the gap and the electrically conductive armatures on the other side of the gap, or where multiple magnetic field arrangements and electrically conductive armatures are used, they may be on both sides of the gap.

The moving magnetic field arrangement may be on the carriage, and may comprise moving permanent magnets. The magnets may be on a rotor, and may be arranged as generators of a cylindrical rotor.

The magnets may, however, be arranged on the face of a disc. The magnets may, in another arrangement, be arranged on a belt trained over pulleys. The magnets may be moved by electric motor means. The magnets may be arranged on the rotor of an electric motor.

In another arrangement, the moving magnetic field arrangement comprises electromagnets. In a traction arrangement, the electromagnets may be fixed in the carriage and their polarity changed to create a moving magnetic field.

However, the moving magnetic field arrangement may be on the track, and the armature on the carriage. The moving magnetic field arrangement may comprise electromagnets, which may be disposed along the track and controlled to create a moving magnetic field generating eddy current when the carriage is adjacent them. Where the track is long, this could be expensive, but for low-rise elevators, say freight elevators or dumb waiters, it would have practical advantages. The armature may comprise a metal plate.

The metal may be paramagnetic, and may comprise a metal of good electrical conductivity, such as aluminum and/or copper.

The carriage may comprise an elevator car or a railway or tramway carriage or an engine pulling carriages or freight trucks. The invention also comprises a ropeless elevator system comprising a traction arrangement according to one or another arrangement set out above.

The carriage may comprise a moving magnetic field arrangement supplied with external electric power.

The carriage may draw power from conductors extending along the track, either by conduction through contacts or, in a non-contact fashion, inductively. The carriage may comprise an onboard power supply, which may comprise battery means, and may comprise a UPS arrangement.

The system may comprise a control arrangement adapted to control movement of the carriage according to command signals.

The system may comprise emergency braking and/or arrest means. Such means may themselves comprise eddy current braking means, but may also comprise mechanical arrangements.

In an elevator system, with vertical movement effected by eddy current means, when a carriage is stopped at a floor, a mechanical arrangement may be deployed to hold it stationary. Such an arrangement may, for example, comprise deadbolts extending between carriage and track. Without such provision, a control system would need to continually adjust the eddy current means to accommodate the changing weight of the carriage as passengers or freight left or joined the carriage. With such provision, the eddy current means can be turned off, or set to stand by, saving power. To start from stationary, power is restored and ramped up until the weight is taken off the deadbolts, as may be determined by load cell arrangements, for example.

The system may comprise provision for lateral as well as vertical movement. The lateral movement provision may comprise eddy current drive means.

This is, of course, a great advantage of a ropeless elevator system, inasmuch as, on the one hand, more than one carriage can operate in a single shaft, and, on the other hand, one carriage can operate in more than one shaft. This could be of interest in connection with building complexes, where elevator carriages can move in tunnels or bridges between buildings.

Lateral movement could, of course, be on rails, rather than the carriage being suspended by eddy current arrangements, but, of course, traction along the rails can be provided by eddy current arrangements. Instead of conventional rails, a maglev arrangement could be used.

The track may comprise a guide rail for a vehicle such as a rail car or rail freight truck, or a tractor for a train of carriages or trucks, which also comprises the armature of the traction arrangement. An eddy current motor arrangement for such a ‘horizontal’ system can be any of the arrangements above-mentioned. A particularly simple system comprises a rail having a rectangular cross-section, an eddy current arrangement straddling the rail. The eddy current arrangement may be capable of generating forces both vertically and horizontally, the vertical force lifting the eddy current generator up off the top of the rail, the horizontal force driving the carriage along the rail. The vertical and horizontal forces may be generated by the same or different eddy current arrangements. Each eddy current arrangement may comprise separate magnetic components e.g. discs, for generation of vertical and horizontal forces. A control system controls the force direction according as lift or lift and forward (or reverse) motion along the rail is required.

The rail may contain insulated conductors supplying power to the arrangement.

### DESCRIPTION OF THE DRAWINGS

Traction, and particularly elevator traction, arrangements according to the invention will now be described with reference to the accompanying drawings, in which:

FIG. 1 is a front elevation of an elevator carriage with a first embodiment of an eddy current traction arrangement;

FIG. 2 is a plan view of the carriage of FIG. 1;

FIG. 3 is an end view of an eddy current driver of the carriage of FIG. 1;

FIG. 4 is a part front elevation of an elevator carriage with a second embodiment of an eddy current traction arrangement;

FIG. 5 is a diagrammatic illustration of another embodiment of an eddy current drive;

FIG. 6 is a diagrammatic illustration of yet another embodiment of an eddy current drive;

FIG. 7 shows a carriage supporting arrangement at a floor stop;

FIG. 8 is a diagrammatic illustration of a shaft transfer arrangement;

FIG. 9 is an illustration of an elevator shaft with passing places;

FIG. 10 is a cross section of a horizontal track arrangement with an eddy current traction arrangement providing both levitation and movement along the track;

FIG. 11 is a side view of the arrangement of FIG. 10, and

FIG. 12 is a view of a monorail system according to the invention.

### DETAILED DESCRIPTION

The drawings illustrate traction arrangements 11 comprising:

a track 12;

a carriage 13;

guide means 14a guiding the carriage 13 along the track 12 with a predetermined carriage/track gap 15; and eddy current means 16 generating eddy current across the gap 15 giving rise to a traction force.

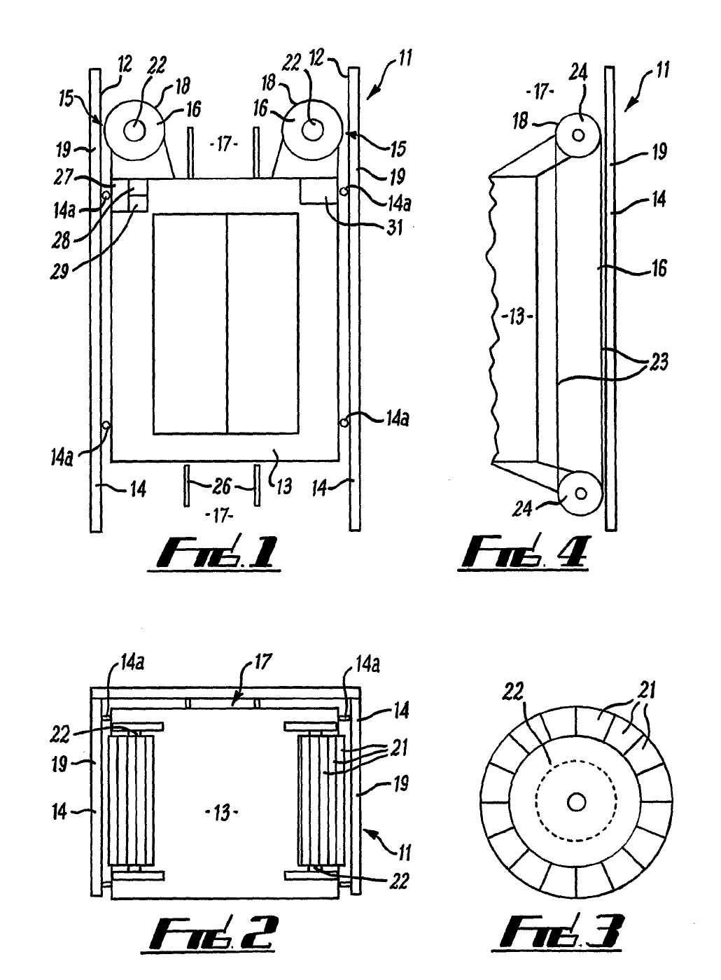

FIGS. 1 and 2 illustrate the traction arrangement 11 in the context of an elevator arrangement, in which an elevator carriage 13 travels in a shaft 17 comprising the track 14.

The eddy current means comprise a moving magnetic field arrangement 18 on one side of the gap and an electrically conductive armature 19 on the other side of the gap.

In all illustrated embodiments, the moving magnetic field arrangement 18 is on the carriage 13. In the embodiments of FIGS. 1-5, the moving magnetic field arrangement 18 comprises moving permanent magnets 21.

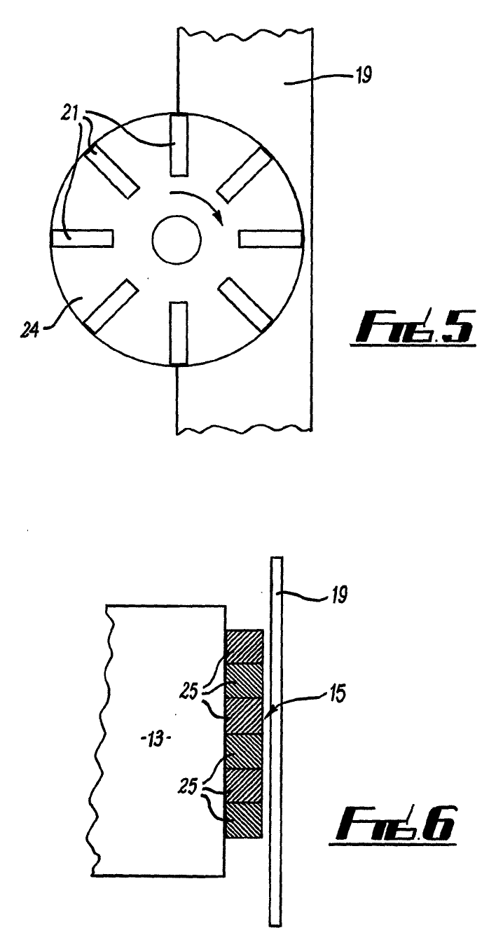

In the embodiment of FIG. 1-3, the magnets 21 are on a rotor 22—see particularly FIG. 3—and are arranged as generators of a cylindrical rotor. On the carriage 13, there are two electric motor driven rotors 22, situated one on each side of the carriage 13.

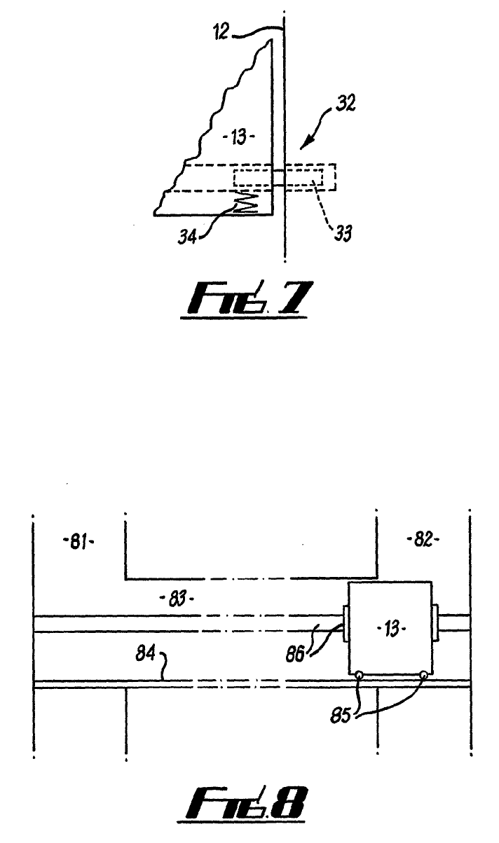

In the embodiment of FIG. 5, the magnets 21 are arranged on the face of a disc 24. Here, the armature 19 lies behind half of the disc 24. If the magnets 21 are electromagnets, however, the armature can underlie the entire disc, the polarity of the electromagnets changing every half-revolution as they reach top dead centre, in the case of vertical movement, or extreme right and left positions, in the case of horizontal movement, so that both halves of the disc contribute positively to the traction force.

FIG. 4 illustrates in another arrangement, in which the magnets 19 are arranged on a belt 23 trained over pulleys 24.

In the arrangement illustrated in FIG. 6, the moving magnetic field arrangement comprises electromagnets 25. The electromagnets are fixed in the carriage 13, and their polarity changed by a control arrangement to create a moving magnetic field. In effect, the control arrangement will simulate the moving magnets of previous embodiments. Of course, there will here be no moving parts, if the control can be effected by solid state control means, and this will be a particularly advantageous arrangement from a mechanical point of view.

Clearly, the moving magnetic field arrangement 18 may be on the track 12, and the armature 19 on the carriage 13. The moving magnetic field arrangement may comprise electromagnets, which may be disposed along the track and controlled to create a moving magnetic field generating eddy current when the carriage is adjacent them. Where, as will generally be the case, the track is long compared to the carriage, it will be more practical to arrange the field arrangement 18 on the carriage 13.

The armature 19 comprises metal plate of aluminum and/or copper, which are paramagnetic metals of good conductivity, well suited to eddy current motors.

The moving magnetic field arrangement 18 on the carriage 13 is supplied with external electric power, drawn from conductors 26 extending along the track 12.

The carriage comprises an onboard power supply 27, which comprises battery means 28, and a UPS arrangement 29, to provided uninterrupted power in the event of failure of the supply through the conductors 26.

The system comprises a control arrangement 31 adapted to control movement of the carriage 13 according to command signals.

The system comprises emergency braking and/or arrest means. In the event of total power failure, permanent magnet eddy current drive means will provide braking, provided the magnets themselves are not permitted to move—the rotors 22, disc 24 or belt 23 should be locked in the event of power failure, or even, where there is emergency power for the carriage 13, driven in reverse. This braking effect is already used, of course, in fairground thrill rides. Conventional mechanical emergency braking may however be additionally provided, if only to give confidence to passengers, it being noted, however, that ropeless elevators do not have counterweights, and there will be an increased mechanical requirement on that account (although, of course, elevator pioneer Otis demonstrated the efficacy of his safety arrest system by actually cutting the rope).

When the carriage 13 is stopped at a floor, a mechanical arrangement 32 is deployed as illustrated in FIG. 7 to hold it stationary. Deadbolts 33 extending between carriage 13 and track 12 are deployed automatically at a floor stop, as by electromagnets, electric motors or hydraulic rams. Without such provision, the control arrangement 31 would need to continually adjust the eddy current means to accommodate the changing weight of the carriage 13 as passengers or freight left or joined the carriage 13. With such provision, the eddy current means can be turned off, or set to stand by, saving power. To start from stationary, power is restored and ramped up until the weight is taken off the deadbolts 33, as determined by load cell arrangements 34.

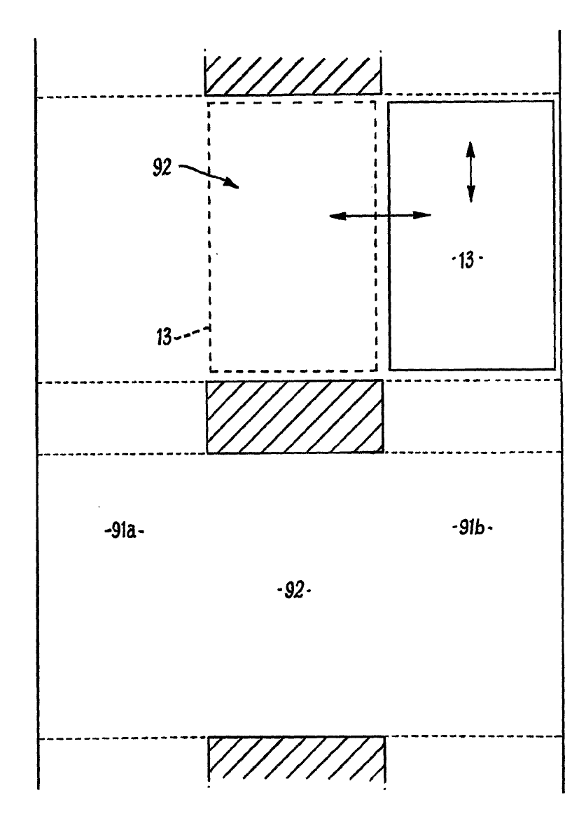

The systems illustrated in FIGS. 8 and 9 comprise provision for lateral as well as vertical movement, the lateral movement provision also comprising eddy current drive means. FIG. 8 illustrates two elevator shafts, 81, 82, with a lateral passage 83 therebetween.

In this arrangement, at the level of the lateral passage 83, the carriage 13 has the option to extend track 84 engaging wheels 85 extending along the passage 83 and be moved therealong by a further eddy current drive arrangement 86. Instead of a conventional rail arrangement with rail-engaging wheels, a maglev arrangement could be used. The system could, however, avoid the need for rails by moving the carriage purely by eddy current arrangements.

This is, of course, a great advantage of a ropeless elevator system, inasmuch as, on the one hand, more than one carriage can operate in a single shaft, by having passing points at which one carriage can be moved sideways clearing the way for, say, an express elevator, and, on the other hand, one carriage can operate in more than one shaft. This facilitates connection within building complexes, where elevator carriages can move in tunnels or bridges between buildings.

In one arrangement, illustrated in FIG. 9, an elevator shaft 91 has at each floor provision for lateral movement of the carriage 13, to a parking position 92, freeing up the shaft 91 for the passage of other carriages. As shown, there are two parallel shafts 91a, 91b, sharing parking positions 92.

Whilst the invention has so far been described particularly in the context of elevator systems, where it appears to have special utility, there are clearly many other applications.

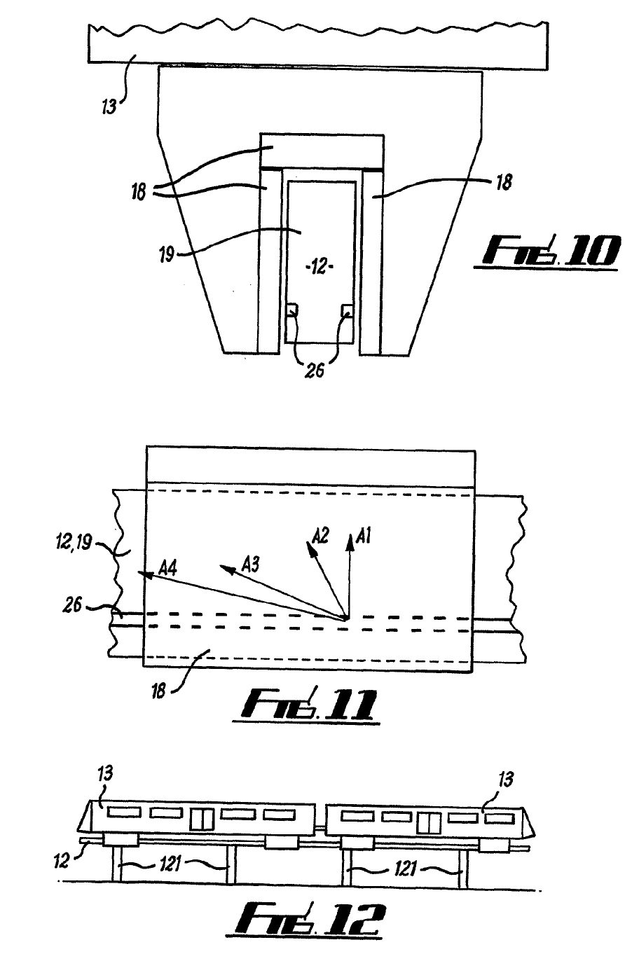

FIGS. 10, 11 and 12 illustrate a railway or tramway arrangement. Carriages 13 sit astride a monorail track 12 that doubles as the armature 19 of an eddy current traction arrangement comprising eddy current generators 18 and armature 19. Three connected generators are disposed either side of and atop the rail 12. As shown in FIG. 11, the eddy current arrangement generates a force as indicated by arrows A1, A2, A3, A4.

Arrow A1 indicates a vertical force which levitates the carriage 13 from the rail 12 when it is about to move off. The force is vectored as indicated by arrow A2, A3, A4 to provide forward (or reverse) movement along the track 12.

The rail track 12 is deployed on stanchions 121, FIG. 12. The rail 12 has embedded insulated conductors 26 from which the carriage 13 derives power to operate the eddy current arrangement as well as internal services such as air conditioning, lighting and communications. As before, suitable control and back-up power systems can be provided.

In this arrangement, the track is especially inexpensive, compared to conventional rail track, and especially to conventional maglev track. The eddy current arrangements are also inexpensive, as compared to large electric motors or diesel-electric arrangements, and should require very much less maintenance. As, moreover, there is no contact, when in motion, between carriage and track, there is no frictional or rolling resistance, and ride should be smoother. There is, moreover, no reliance on wheel-rail friction, and track can be elevated sufficiently to be clear of snow and flood.

While conventional railway trains, having an engine and towed carriages or trucks, can have an engine powered in this way, maximum advantage is seen in providing each carriage or truck with its own eddy current drive arrangement which also serves to levitate it.

The system described above allows movement up/down steeper gradients than are otherwise possible with conventional railway systems.

1. (canceled)

2. (canceled)

3. (canceled)

4. (canceled)

5. (canceled)

6. (canceled)

7. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. A traction system comprising:
a carriage comprising a moving magnetic field arrangement;
a vertical track and a traverse track, wherein the vertical track extends vertically and the traverse track extends transversely to the vertical track;
an armature, wherein the armature is located adjacent to the carriage and is electrically conductive;
guide means for guiding the carriage along the vertical track and traverse track for establishing a predetermined gap between the carriage and the armature; and
a control arrangement adapted to generate command signals to control the moving magnetic field arrangement, wherein the moving magnetic field arrangement as controlled by the command signals is cooperable with the armature to provide eddy current drive to propel the carriage along the vertical and transverse tracks.

38. The traction system according to claim 37, wherein the armature comprises a metal plate.

39. The traction system according to claim 38, wherein the metal is paramagnetic.

40. The traction system according to claim 38, wherein the metal is selected from the group consisting of copper and aluminum.

41. The traction system according to claim 37, wherein the moving magnetic field arrangement comprises moving permanent magnets.

42. The traction system according to claim 41, wherein the permanent magnets are on a rotor.

43. The traction system according to claim 41, wherein the permanent magnets are arranged on the face of a disc.

44. The traction system according to claim 41, wherein the permanent magnets are arranged on a belt trained over pulleys.

45. The traction system according to claim 37, wherein the moving magnetic field arrangement comprises electromagnets.

46. The traction system according to claim 45, wherein the control signals change a polarity of the electromagnets so as to create a moving magnetic field.

47. The traction system according to claim 37 further comprising emergency braking means.

48. A traction system comprising:
a carriage comprising an armature, wherein the armature is electrically conductive;
a vertical track and traverse track, wherein the vertical track extends vertically and traverse track extends transversely to the vertical track;
a moving magnetic field arrangement, wherein the moving magnetic field arrangement is located adjacent to the armature;
guide means for guiding the carriage along the vertical track and traverse track and for establishing a predetermined gap between the carriage and the armature; and
a control arrangement adapted to generate command signals to control the moving magnetic field arrangement, wherein the moving magnetic field arrangement as controlled by the command signals is cooperable with the armature to provide eddy current drive to propel the carriage along the vertical and transverse tracks.

49. The traction system according to claim 48, wherein the armature comprises a metal plate.

50. The traction system according to claim 49, wherein the metal is paramagnetic.

51. The traction system according to claim 48, wherein the metal is selected from the group consisting of copper and aluminum.

52. The traction system according to claim 48, wherein the moving magnetic field arrangement comprises moving permanent magnets.

53. The traction system according to claim 52, wherein the permanent magnets are arranged on a belt trained over pulleys.

54. The traction system according to claim 48, wherein the moving magnetic field arrangement comprises electromagnets.

55. The traction system according to claim 54, wherein the control signals change a polarity of the electromagnets so as to create a moving magnetic field.

56. The traction system according to claim 48 further comprising emergency braking means.
